(19) United States
(12) Patent Application Publication
(10) Pub. No.: US 2005/0154602 A1
(43) Pub. Date: Jul. 14, 2005

(54) Parcel pick up notification apparatus and method

(76) Inventor: Allen David Hertz, Boca Raton, FL (US)

Correspondence Address: ALLEN D. HERTZ, 12784 TULIPWOOD CIRCLE, BOCA RATON, FL, 33428, US

(21) Appl. No.: 10/754,998

(22) Filed: Jan. 10, 2004

(51) Int. Cl. G06F 17/60

(52) U.S. Cl. 705/1

(57) ABSTRACT

The present invention describes various methods and apparatus to increase efficiency in the parcel pick up process. Two types can be applied, a wireless parcel deposit monitoring apparatus is installed into a parcel drop box, and a wired parcel pick up request which is located within a customer pick up location. The wireless parcel deposit monitoring apparatus would identify when a parcel is deposited into the parcel drop box and send a request for pick up message to a host computer. The wired parcel pick up request apparatus is a simplistically operated apparatus, wherein the user would simply press a button to request a pick up. The wired parcel pick up request would communicate with a host computer using a wired communication network (Ethernet, Modem, and the like). The host computer would determine if the request for pick up can or can not be accommodated, and respond to the wired parcel pick up request apparatus accordingly. The wired parcel pick up request apparatus would convey the response to the user.

### FIELD OF THE INVENTION

This invention relates in general to an apparatus and method for notification to a parcel delivery service party that a parcel is awaiting pick up at either a customer location or within a parcel depository box.

### BACKGROUND OF THE INVENTION

The present invention is generally related to the use of a messaging device to notify a parcel delivery service party that a parcel (box, letter, etc.) is awaiting pick up at either a customer location or within a parcel depository.

Parcels are picked up at a variety of locations, including customer locations, parcel deposit boxes, parcel processing companies, the parcel delivery service office, and the like.

When a parcel delivery service party is picking up parcels at customer locations, there are several options available today:
1) The Customer calls the parcel delivery service company and requests a pick up.
2) The customer submits a request for pick up using the internet. The customer is required to access the internet, enter information such as location, customer account number, package size, and the like.
3) The parcel delivery service party drives by the customer location on a daily basis regardless of whether a pick up is required.

When a parcel delivery service party is picking up parcels at parcel deposit boxes, the parcel delivery service party is required to visit each site regardless of whether any parcels have been deposited.

Since the parcel delivery service party is required to visit each parcel depository box location, the parcel delivery service company must strategically place each parcel depository box to optimize the pick up route while providing customers with reasonable locations. This limits the desired locations for the parcel deposit boxes, not placing parcel deposit boxes in areas that are less likely to be used on a daily basis. Some examples would be residential areas, schools, and warehouse areas.

When a parcel delivery service party is required to visit a location on a daily basis, the required steps of driving to each location and inquiring whether a parcel is being picked up increases the operating costs of the parcel delivery service company in both manpower and energy (fuel). Further, the excess stopovers dictate an earlier pick up time for the parcels.

The current process required for a customer to notify the parcel delivery service company that they have a package that requires a pick up is cumbersome and would not be conducive to daily support from the customer.

What is desired is a means to notify the parcel delivery service company and more specifically (directly or indirectly) the parcel delivery service party that a pick up is required at a specific location. Further, it would be beneficial if the apparatus could validate that the customer made the request for pick-up at a time whereby the parcel delivery service party will still be able to pick up the parcel.

### SUMMARY OF THE INVENTION

The present invention addresses the deficiencies in the present state of picking up parcels from customer locations and parcel drop boxes.

A first aspect to the present invention is the ability to notify a parcel delivery service party to retrieve a parcel.

A second aspect to the present invention is the ability to monitor a parcel depository box, identify when a parcel is deposited, and transmit a notification message.

A third aspect of the present invention is the inclusion of a sensor to monitor a parcel depository box and identify when a parcel is deposited.

A forth aspect of the present invention is the inclusion of a sensor to monitor a parcel depository box and identify when a parcel passes through an opening in the parcel depository box.

A fifth aspect of the present invention is the inclusion of a sensor to monitor a parcel depository box and identify when a parcel passes through an access tunnel in the parcel depository box.

A sixth aspect to the present invention is the inclusion of a sensor to monitor a parcel depository box and identify when a parcel passes through a cross sectional location of a body of the parcel depository box.

A seventh aspect to the present invention is the inclusion of a sensor to monitor a parcel depository box and identify when a parcel contacts the base of the parcel depository box.

An eighth aspect of the present invention is the ability to turn the sensor system on when an access door of the parcel depository box is opened.

A ninth aspect of the present invention is the ability to identify when the first parcel is deposited into the parcel depository box.

A tenth aspect of the present invention is the ability to turn the transmitter on when a parcel is deposited into the parcel depository box.

An eleventh aspect of the present invention is the ability to turn the transmitter on when the first parcel is deposited into the parcel depository box.

A twelfth aspect of the present invention is the ability to transmit a message indicating a parcel has been deposited within the parcel depository box.

A thirteenth aspect of the present invention is the inclusion of at least one solar power panel as a power source.

A fourteenth aspect of the present invention is the inclusion of at least one solar power panel as a means for recharging the battery(s).

A fifteenth aspect of the present invention is the inclusion of a power source that operates using the motion of the access door of the parcel depository box for at least one of powering the system and recharging the battery,(s)

A sixteenth aspect of the present invention is the ability to transmit a message from the parcel depository box to a central computer.

A seventeenth aspect of the present invention is the ability to transmit a message from the parcel depository box to a central computer, whereby the central computer then transmits a message to the parcel delivery service party.

An eighteenth aspect of the present invention is the ability to modify a pick up route of the parcel delivery service party as a result of transmitted information from the parcel deposit boxes.

A nineteenth aspect of the present invention is the ability to modify a pick up route of the parcel delivery service party as a result of transmitted information from the parcel deposit boxes and convey that information to the parcel delivery service party.

A twentieth aspect of the present invention is a ability of the parcel deposit boxes identify if the parcels have already been picked up.

A twenty-first aspect of the present invention is a ability of the central computer to inform the parcel deposit boxes if it is beyond an acceptable time for a pick up at the respective location.

A twenty-second aspect of the present invention is the use of paging (flex, reflex, reflex 50), cellular (CDMA, Analog, GSM, push to talk, etc.), blue-tooth, Wi-Fi, radio, and the like transmission protocols.

A twenty-third aspect of the present invention is the ability to notify the parcel delivery service company that a parcel is awaiting pick up at a customer site.

A twenty-forth aspect of the present invention is the ability to use the internet to notify the parcel delivery service company that a parcel is awaiting pick up at a customer site.

A twenty-fifth aspect of the present invention is the ability to use a modem to notify the parcel delivery service company that a parcel is awaiting pick up at a customer site.

A twenty-sixth aspect of the present invention is an apparatus that is preprogrammed to notify the parcel delivery service company that a parcel is awaiting pick up at a customer site.

A twenty-seventh aspect of the present invention is an apparatus that utilizes at least one of a switch and a button, whereby once the at least one of a switch and a button changes state, the unit transmits a message to the parcel delivery service company to inform the parcel delivery service company that a parcel is awaiting pick up at a specific customer site.

A twenty-eighth aspect of the present invention is the inclusion of a circuit which activates a global positioning system upon any abnormal motion, wherein the abnormal motion would suggest vandalism or theft of the Parcel Deposit Box.

A twenty-ninth aspect of the present invention is the inclusion of an automated payment system.

A thirtieth aspect of the present invention is the inclusion of a credit card, debit card, or smart card payment system.

A thirty-first aspect of the present invention is the inclusion of a barcode reader for reading the parcel tracking information.

A thirty-second aspect of the present invention is whereby the means to automate payment for the shipping charges utilizes payment made through a payment process using a cell phone or other transceiving device.

A thirty-third aspect of the present invention is whereby the means to automate payment for the shipping utilizes a keypad.

A thirty-fourth aspect of the present invention is whereby the means to automate payment for the shipping utilizes a pre-paid card or similar device.

A thirty-fifth aspect of the present invention is whereby the means to automate payment for the shipping is in conjunction with the transmitter used for monitoring the deposition of a parcel within the parcel deposit box.

A thirty-sixth aspect of the present invention is the inclusion of an automated camera.

A thirty-seventh aspect of the present invention is the inclusion of a tilt sensor(s) to identify vandalism.

A thirty-eighth aspect of the present invention is the ability to interchange tilt sensors using a pin and socket with different tilt sensors assemblies to change the angle of activation.

A thirty-ninth aspect of the present invention is the inclusion of a closed loop acknowledgement of the communication between the external monitoring device and the host computer.

A fortieth aspect of the present invention is the ability to retransmit messages when the close loop acknowledgement is not completed.

A forty-first aspect of the present invention is the ability to transmit a status message at a predetermined time to ensure a package pick up is not missed.

A forty-second aspect of the present invention is the application of a single switch remote access apparatus for requesting a pick up by a taxi cab.

A forty-third aspect of the present invention is the application of a single switch remote access apparatus for requesting a pick up for medical waste.

A forty-fourth aspect of the present invention is the application of a single switch remote access apparatus for monitoring inventory within a vending machine, whereby the user interface would actually be sensors in each of the individual inventory locations.

A forty-fifth aspect of the present invention is the application of a single switch remote access apparatus for monitoring the inventory level in an ice machine.

A forty-sixth aspect of-the present invention is the application of a single switch remote access apparatus for monitoring the level within a gas storage tank.

A forty-seventh aspect of the present invention is the application of a single switch remote access apparatus for monitoring the level within a CO2 storage tank.

A forty-eighth aspect of the present invention is the application of a single switch remote access apparatus for monitoring any abnormal motions with a pool, more specifically when a person may have fallen in.

A forty-ninth aspect of the present invention is the application of a single switch remote access apparatus for monitoring any abnormal motions with a pool, more specifically when a person may have fallen in and the inclusion of a camera for remote verification of a potential drowning.

A fiftieth aspect of the present invention is the application of a single switch remote access apparatus for monitoring a utility meter.

A fifty-first aspect of the present invention is the ability to change the information conveyed to the user by changing the label of the single switch remote access apparatus, thus allowing the same apparatus to be used in a variety of applications without any hardware changes.

A fifty-second aspect of the present Invention is the ability to program any required “preprogrammed information” (external contact information, customer site location, etc.) into the single switch remote access apparatus.

A fifty-third aspect of the present Invention is the ability to program any required “preprogrammed information” into the single switch remote access apparatus using software that is accessed at a website.

### BRIEF DESCRIPTION OF THE DRAWINGS

For the purpose of initially illustrating the invention, there is shown in the flow diagram, an embodiment that is presently preferred. It should be understood, however, that the present invention is not limited to the specific instrumentalities and methods disclosed. It can be recognized that the flow diagram represents a method and the associated apparatuses required to make the method in which persons skilled in the art may make various flow and interface diagrams from therein. In the drawing:

FIG. 1 is a flow chart diagram illustrating the steps of the preferred embodiment for achieving the desired invention. It is understood that the order or process steps may deviate from the flow diagram provided, while maintaining the spirit and intent of the present invention.

FIG. 2 is an isometric view of a parcel drop box illustrating the aspects of the present invention.

FIG. 3 is a flow chart diagram illustrating the steps of a power conservation system for a remote monitoring system.

FIG. 4 is a flow chart diagram illustrating the steps for ensuring the proper status of a parcel drop box is conveyed to a parcel delivery company.

FIG. 5 is an isometric view of a single switch remote request apparatus illustrating the primary features of the present invention.

FIG. 6 is an architectural system diagram illustrating the functional architecture of the single switch remote request apparatus.

FIG. 7 is a flow chart diagram illustrating the steps of the single switch remote request apparatus.

FIG. 8 is a flow chart diagram illustrating the steps of the external host computer, more specifically applied to a parcel pick up request.

### DETAILED DESCRIPTION OF THE DRAWINGS

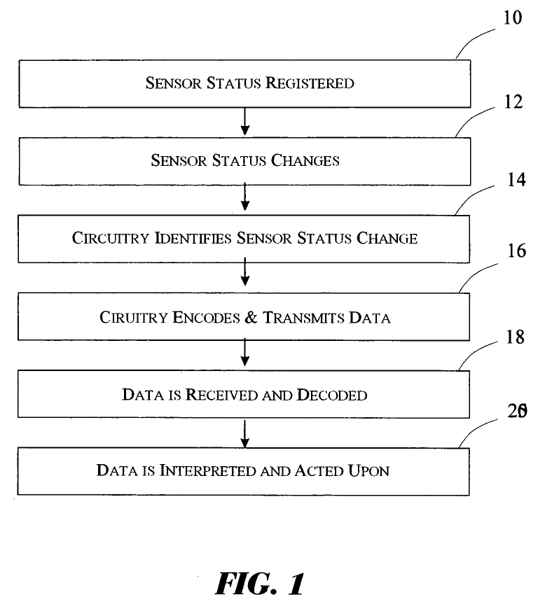

FIG. 1 represents a flow diagram providing a general template for the present invention. FIG. 1 presents the steps of a general automated notification system. Prior to or during a first step 10, the automated notification system is installed into the device to be monitored and turned on. In the first step 10, the automated notification system registers the status of at least one of the monitoring sensors. In a second step 12, at least one of the monitoring sensors changes state. In a third step 14, the change in state of the monitoring sensor(s) is monitored by the automated notification system. Once the status of the monitoring sensor exceeds a predetermined status, the automated notification system identifies the change in state of the monitoring sensor and then acts in a preprogrammed manner to communicate the change in state of the monitoring sensor. In a fourth step 16, the automated notification system encodes the information and transmits the information to the desired external link. The information would be encoded in a manner respective to the protocol selected. Such wireless protocols include SMS, GPRS, ReFlex, ReFlex 50, CDMA, VHF, IP, Radio (such as provided by Nextel™), and the like. The wireless transmitter or transceiver would be one respective to the network selected. Such transceivers would include those capable of transmitting in GSM, CDMA, Radio, VHF, UHF, Wi-Fi, Bluetooth, and the like. Alternatively, the transmission can be accomplished using wired technology, such as using an Ethernet connection within a network and eventually communicating using the internet or as using a modem and communicating using standard telephone lines. In a fifth step 18, the information is received and decoded from the apparatus being monitored to the desired external link. In the preferred embodiment, the external desired link would be a centralized computer. Alternatively, the external link can be a text-messaging device carried by a service person. In a sixth step 20, the decoded data is interpreted and acted upon. This can be using an automated process, human interpretation, or a combination therein.

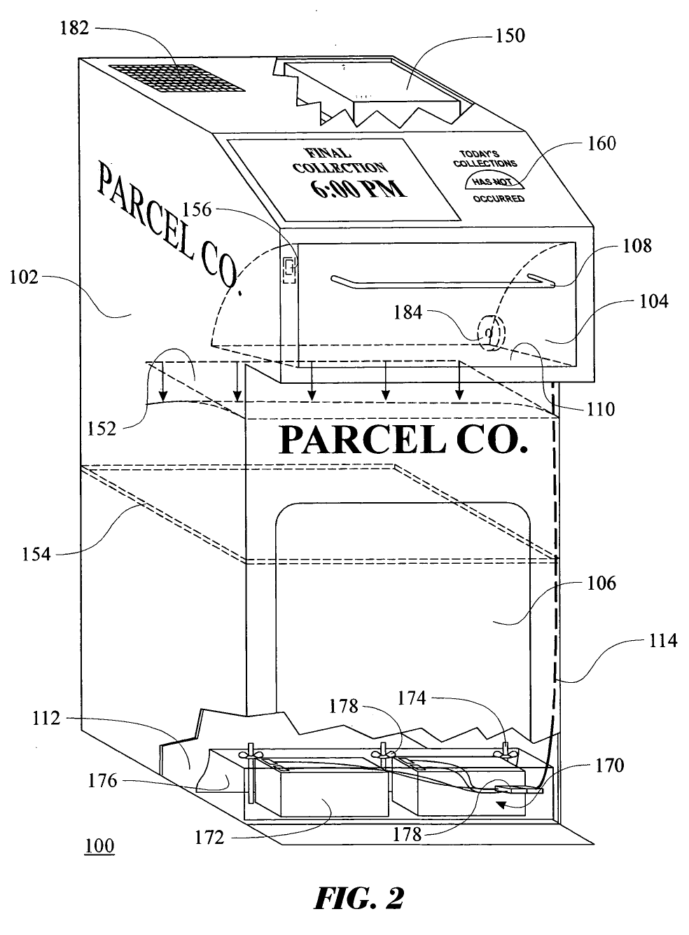

FIG. 2 is an isometric illustration of a representative parcel drop box 100. The parcel drop box 100 comprises a parcel drop box enclosure 102 a parcel drop box customer access door 104, and a parcel drop box service access door 106. The parcel drop box enclosure 102 would be a weather-protecting enclosure that also limits access to deposited parcels to service persons. This is commonly known today. The customer would deposit a parcel (not shown) through the parcel drop box customer access door 104 by pulling on the parcel drop box customer access door handle 108. The parcel drop box customer access door 104 is moveably coupled to the parcel drop box enclosure 102. In the preferred embodiment, the parcel drop box customer access door 104 would be hinged to the parcel drop box enclosure 102. The parcel drop box customer access door 104 can optionally have a parcel loading shelf 110. The customer would open the parcel drop box customer access door 104 and place the parcel onto the parcel loading shelf 110. The parcel loading shelf 110 would guide the parcel during the deposition process. The present invention provides several means for identifying when a parcel is deposited within the parcel drop box 100, such as a cantilevered parcel monitor 152. When a parcel is deposited, the parcel passes across any of a number of types of parcel sensors installed in the parcel drop box 100, causing the sensor to at least temporarily change state. Two sensors illustrated include a cantilevered parcel monitor 152 and a proximity sensor 154. Alternatively, a sensor can be installed to monitor if an object contacts the base 112 of the parcel drop box 100. A computer processing unit (CPU) (not shown) monitors the parcel sensor(s) and identifies any change in state. In the preferred embodiment, the CPU would identify when the parcel sensor changes state, determine if the parcel is the first parcel deposited, if yes—would turn the transmitter on, encode a message communicating the desired state of the parcel drop box 100 (if a parcel is deposited), instruct the transceiver to transmit a message, wait for a verification acknowledgement of the message (repeat the transmission if not acknowledged) and upon acknowledgement, turn the transceiver off. The cantilevered parcel monitor 152 can be a mechanical switch that is activated by the weight of the parcel as it passes from the parcel loading shelf 110 towards the base 112. The proximity sensor 154 could be a large coil wherein the coil creates a magnetic flux. The magnetic flux is changed when an object passes through the coil. Alternatively, a proximity sensor or series of proximity sensors can be installed to detect when an object passes a predetermined position with then parcel drop box enclosure 102. The sensor would be electrically connected to the CPU. The CPU would be electrically connected to a power source 170 and a transceiver 150 via a wiring harness 114. The power source 170 can be a battery 172 (or series of batteries).

In the preferred embodiment, the battery 172 is mounted at the base 112 of the parcel drop box 100 using a series of battery mounting studs 174. The battery mounting studs 174 can be coupled to a baseplate (not shown), wherein the baseplate would be coupled to the base 112 using an adhesive. A battery cover 176 would comprise a securing slot (not shown) respective to each of the battery mounting studs 174. The battery cover would be positioned whereby the battery mounting studs 174 protrude through the securing slots within the battery cover 176. The battery cover 176 would then be secured by placing a washer (not shown) and a wing-nut 178 over each of the battery mounting studs 174. The battery cover 176 can be manufactured from a plastic rain gutter, cut to length, and turned upside down. The battery 172 would be electrically coupled to the system using a quick disconnect 180, thus allowing for simple exchange with a recharged battery 172. It would be preferable for the service person to have access to the battery 172 when opening the parcel drop box service access door 106.

In the preferred embodiment, the transceiver 150 is a Nokia M31 transceiver. The transceiver 150 is interconnected to a logic circuit (not shown), wherein the logic circuit comprises a CPU, a voltage regulating circuit, clocking crystal(s), fuse(s), and respective diodes, capacitors and resistors. The logic programmed into the CPU will be detailed further within the specification. The circuit board provides voltage regulator(s) to convert the power circuit from the input voltage to the voltage required for each of the subcomponents on the circuit as well as the voltage required by the transceiver 150. In the preferred embodiment, the Nokia M31 utilizes 12 volts for transmission and 5 volts for the various monitoring sensors. The CPU utilizes 3.3 or 5 volts. The transceiver 150 would be electro-mechanically coupled to the logic circuit by a 50 Pin connector.

To conserve battery power, it would be desirable to include a sensor control switch 156 that activates the sensors when the parcel drop box customer access door 104 is opened.

Additional means to provide or conserve power consumption would be to include regenerative power sources such as a solar panel 182 or a generator 184. The generator 184 would be mechanically coupled to the edge of the parcel drop box customer access door 104, whereby when the parcel drop box customer access door 104 is opened, the motion turns the shaft of the generator 184. The generator outputs a voltage which charges the battery 172. It would be advantageous to include a gearing which allows the generator 184 to turn in a single direction and allowed to continue to turn in the single direction using inertia when the parcel drop box customer access door 104 is being closed.

Additional features of the parcel drop box 100 include a pick up status notification 160 if the parcel drop box 100 has been service. This can be include an interface that acknowledges the pick up of a previously transmitted parcel notification; When the service person opens the parcel drop box service access door 106, the process can cause the pick up status notification 160 to change status from “has not” occurred to “has” occurred. The same process would cause the transmitter to send an acknowledgement communication to the host computer to provide a close loop system. A bulk transmission to the transceivers 150 of all of the field units can reset the pick up status notification 160 to reset the status from “has” occurred to “has not” occurred. A timer or a light sensitive diode can alternatively be used to reset the status from “has” occurred to “has not” occurred.

It can be recognized that although the preferred embodiment utilizes the Nokia M31 transceiver, alternative transceivers such as other cellular protocols, paging, radio, VHF, UHF, and the like can be incorporated.

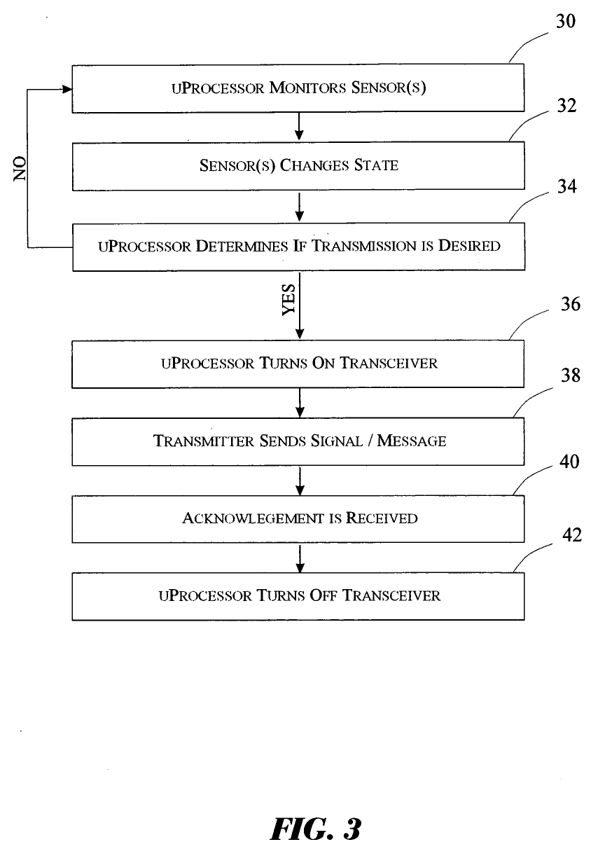

FIG. 3 is of a flow diagram describing the means for reduced battery consumption. The power consumption of the transceiver 150 is very high when compared to the power consumption of the uProcessor. In a first battery saving step 30, a uProcessor monitors each of the various sensors (described above). In a second battery saving step 32, any one of the sensors change state. The uProcessor identifies that the state of any one of the sensors has changed. In a third battery saving step 34, the uProcessor utilizes pre-programmed logic to determine if the change in state requires some additional action or communication with the host computer. If the logic determines that no action is desired, the uProcessor returns to the first battery saving step 30. If the logic determines that action is desired, the uProcessor continues to a fourth battery saving step 38, and turns the transceiver 150 on. The uProcessor waits until at least one of a predetermined time and an acknowledgement that the transceiver 150 is synchronized with the communications network. In a fifth battery saving step 38, then the uProcessor conveys a message respective to the change in status of the sensor(s) and instructs the transceiver 150 to transmit the respective message. In a sixth battery saving step 40, the transceiver receives an acknowledgement from at least one of the communication network and the host computer ensuring the correct information was communicated to the host computer or other recipient. In the seventh battery saving step 42, the uProcessor determines at least one of the acknowledgement is complete and a predetermined length of time has passed, and then turns the transceiver 150 off.

The system without the battery savings steps results in a maximum battery life of 6 weeks using two 12 volt, 7.2 Amp hour batteries in parallel. The system with the battery savings steps results in a minimum battery life of 4.5 months using one 12 volt, 7.2 Amp hour battery. This enhancement provides significant savings in field service efforts.

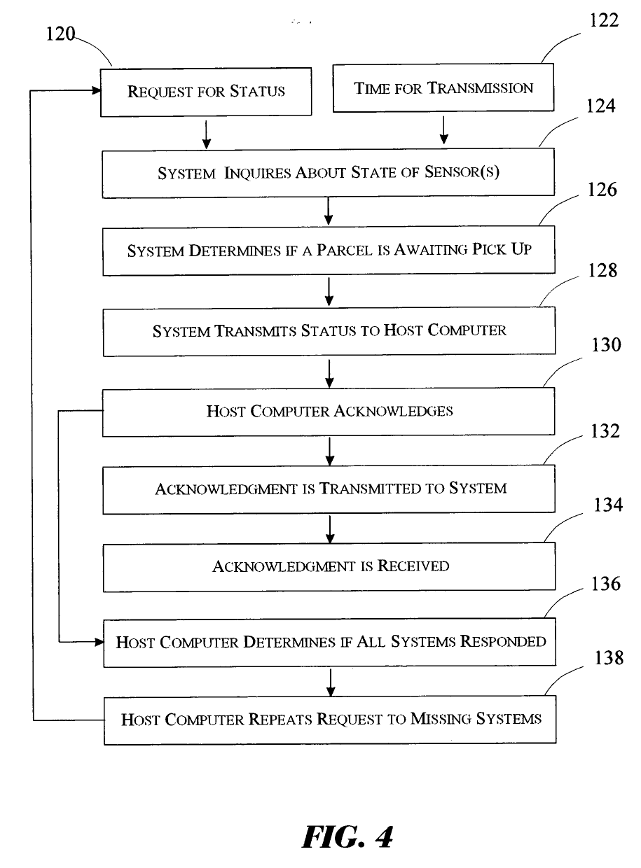

FIG. 4 is a flow diagram illustrating the steps of ensuring the status of the parcel drop box 100 is communicated to the parcel delivery company. FIGS. 2 and 3 illustrate an apparatus and method for notifying the parcel delivery company of a parcel being deposited within the parcel drop box 100. This figure illustrates various means to ensure against any missed communications between the parcel drop box 100 and the parcel delivery company. In a first notification assurance step 120, the parcel deposition monitoring system would track the time of day, and at a preprogrammed time, in a second notification assurance step 124, the parcel deposition monitoring system would inquire to the sensor(s) to determine if a parcel was deposited within the parcel drop box 100. In an alternate first notification assurance step 122, the host computer would determine which of the parcel drop boxes 100 have not transmitted requests for pick up since the previous scheduled pick up date. Then, in the second notification assurance step 124, the host computer would transmit requests for verification to each of the parcel drop boxes 100 that have not transmitted requests for pick up since the previous scheduled pick up date. In a third notification assurance step 126, the parcel deposition monitoring system would interpret the status of the sensor(s) to determine if a parcel has been deposited and is awaiting pickup. In a fourth notification assurance step 128, the parcel deposition monitoring system would transmit the status (parcel waiting for pick up or no pick up required) to the host computer. In a fourth notification assurance step 128, the host computer receives the transmission of the status of the parcel drop box 100. IN a fifth notification assurance step 130, the host computer acknowledges receipt of the transmission, interprets the communication, and acts accordingly. If the status indicated that a parcel were present for pick up, the host computer would add the location to the route plan. If the status indicated that no parcel were present for pick up, the host computer would indicate that the parcel drop box 100 responded and is no longer in question. In a sixth notification assurance step 132, the host computer transmits an acknowledgement to the parcel deposition monitoring system. The parcel deposition monitoring system would monitor the time since the original transmission and if an acknowledgement is not received within a predetermined timeframe, the parcel deposition monitoring system would repeat the transmission. In a seventh sixth notification assurance. step 134, the parcel deposition monitoring system receives, interprets and acts accordingly to the acknowledgement transmitted from the host computer. This acknowledgement process can be utilized during the original transmission as well to ensure the communication between the parcel deposition monitoring system and the host computer has been completed. In an eighth notification assurance step 136, the host computer determines which parcel drop boxes 100 have not responded. In a ninth notification assurance step 138, the host computer repeats the request for status transmission to each of the remaining questionable parcel drop boxes 100. The system will request that the service person visit any of the parcel drop boxes 100 that have not communicated with the host computer.

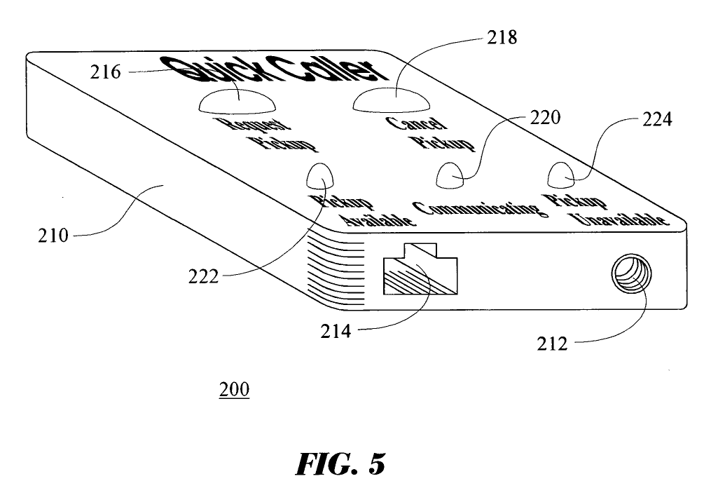

FIG. 5 is an isometric view of a single switch remote access apparatus 200, the apparatus comprising a single switch remote access apparatus housing 210, a power input coupling member 212, and a communications interface member 214. The user would select a remote call actuator 216 to activate the single switch remote access apparatus 200, whereby the single switch remote access apparatus 200 communicates with a predetermined remote device. The remote call actuator 216 can be of any simple activation switches, such as a popple switch, a toggle switch, a push button, a lever switch, and the like. The member type used for the remote call actuator 216 should not limit the scope of the present invention. When the remote call actuator 216 is activated, the single switch remote access apparatus 200 interprets the request, communicates the information/request through the communications interface member 214. In the preferred embodiment, the communications means would be using an Ethernet protocol to communicate to the predetermined remote device. An Ethernet cable would create a connection between the communications interface member 214 and the building computer network. The building computer network provides access to the internet. The information finally reaches its end destination, generally a host computer. During the communication process, the single switch remote access apparatus 200 informs the user that the communication is in process by illuminating a communications indication LED 220. The host computer interprets the information transmitted, responds and acts accordingly. A response is transmitted from the host computer or receiving party to the single switch remote access apparatus 200 using the same network. The single switch remote access apparatus 200 receives the response, interprets the responds and conveys the response to the User. In the preferred embodiment, the single switch remote access apparatus 200 comprises a positive indication LED 222 which illuminates green for positive responses, and a negative indication LED 224 which illuminates red for negative responses. It can be recognized that the two can be combined into a single bi-colored LED wherein the LED would illuminate in a first color indicating a first response and a second color indicating a second response. In the preferred embodiment, the positive indication LED would remain illuminated until the action is completed, indicating the single switch remote access apparatus 200 has been activated. Details of the steps of the communication process will be described in more detail at a later point herein the specification.

The above describes a process for initiating a request. Should the user desire to cancel the request, the user would select a remote call cancellation 218 to activate the single switch remote access apparatus 200 requesting the cancellation of a previously communicated request for action. In the preferred embodiment, a positive response would be indicated by flashing the positive indication LED 222 for a predetermined timeframe and a negative response would be indicated by flashing the negative indication LED 224 for a predetermined timeframe.

It can be recognized that sound, LCD displays, and other machine to human communication means may also be incorporated to communicate with the user.

It can be recognized that the present invention is the utilization of a single switch can include the utilization of two buttons hit simultaneously or in series as a means to try to circumvent a “single switch” element of the claim stated herein. The same stated for a temporary toggle switch or similar. It should be recognized that these are a prima facie case of obviousness.

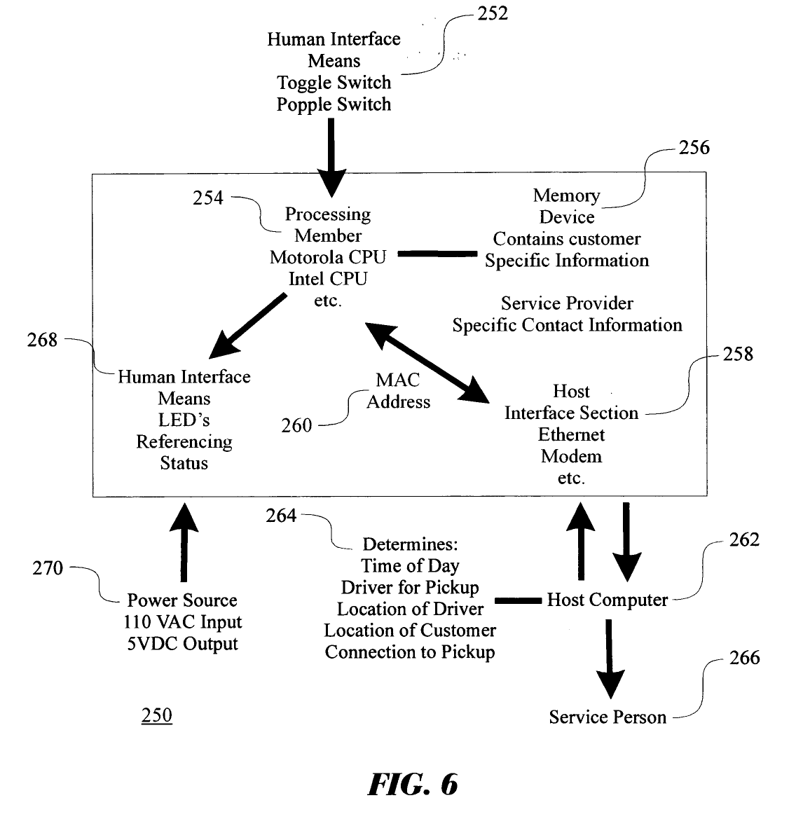

FIG. 6 is a representative diagram in conjunction with the preferred embodiment of the present invention illustrating a single switch remote access architecture 250 of the functional components of the single switch remote access apparatus 200. The device is powered by a power source 270. A uProcessor module 254 monitors a human interface input member(s) 252 for a change in status. Upon a change in state of the human interface input member(s) 252, the uProcessor module 254 obtains any information from a memory module 256 that is required for communicating with a host computer 262. It can be recognized that the memory module 256 may be a subcomponent of the uProcessor module 254. The information required for communication comprising a single switch remote access apparatus electronic identification code 260 such as a MAC address, IP Address, and the like. The uProcessor module 254 communicates with the host computer 262 by using a single switch remote access apparatus to host interface circuitry 258, such as an Ethernet circuit, a modem, and the like. The single switch remote access apparatus to host interface circuitry 258 communicates either directly or indirectly with a host computer 262. The host computer 262 would seek external requested information 264 to make an intelligent decision. If the decision is acceptable and requires action by a service party/end user 266, a message is conveyed to the service party/end user 266 using any of many known wired or wireless communication devices such as a text message to a pager or cell phone, internet, radio, radio dispatch, and the like. Should the host computer determine that it is not acceptable for action by the service party/end user 266, the host computer would convey that determined status to the single switch remote access apparatus 200. The uProcessor module 254 would interpret the communicated response accordingly (accepted or rejected) and convey the response to the user by a human interface output member 268.

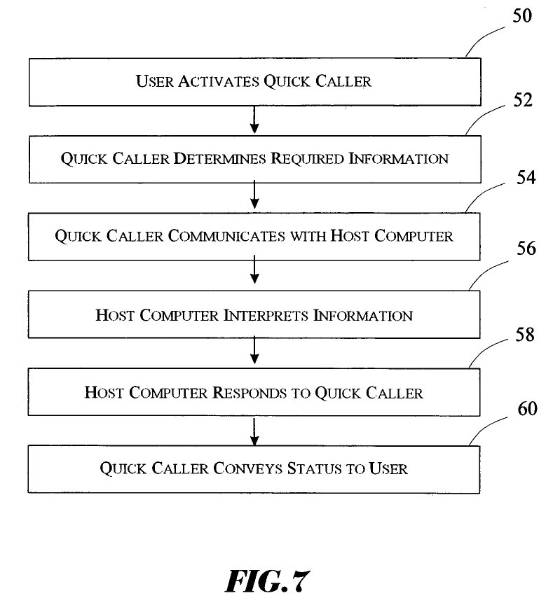

FIG. 7 is of a flow diagram describing the general process flow of a single switch remote access apparatus 200. The user would install the single switch remote access apparatus 200. The installation, in accordance with the preferred embodiment, would be by inserting two screws into a wall and mounting the single switch remote access apparatus 200 by placing two keyhole mounting points (not shown) over the two screws inserted into the wall and lowering the single switch remote access apparatus 200 to slide the smaller portion of the keyhole mounting points over the screws. The user would insert the power cable into the power input coupling member 212. The user would insert a landline connection into the communications interface member 214. The user would complete the installation by programming the unit with the user information, comprising the host computer contact information, the user location, and any additional information required.

In a first single switch remote access step 50, the user would activate the single switch remote access apparatus 200 by selecting one of the human interface input member(s) 252. In a second single switch remote access step 52, the uProcessor module 254 would register the change in state of the human interface input member(s) 252. The uProcessor module 254 interprets the registered change in state of the human interface input member(s) 252. The uProcessor module 254 determines if a communication is required. If the uProcessor module 254 determines that a communication is required, the system continues by a third single switch remote access step 54 wherein the uProcessor module 254 directs the single switch remote access apparatus to host interface circuitry 258 to communicate with the host computer 262. The preferred communications means would be Ethernet or modem (telephone, dsl, cable, and the like), but other communication means such as blue-tooth, Wi-Fi, wireless Ethernet, and the like can be employed. The information would be received by the host computer 262. In the fourth single switch remote access step 56, the host computer 262 interprets the information. The host computer 262 would determine if the request made by the information provided by the single switch remote access apparatus 200 can be acted upon to meet the request generated by the action of the user. In a fifth single switch remote access step 58, the host computer 262 communicates the determined results to the single switch remote access apparatus 200. The single switch remote access apparatus 200 interprets the communicated determined results. In the sixth single switch remote access step 60 the single switch remote access apparatus 200 conveys the determined results to the user via human interface output member 268. The human interface output member 268 can be an LED, a LCD, a speaker, and the like.

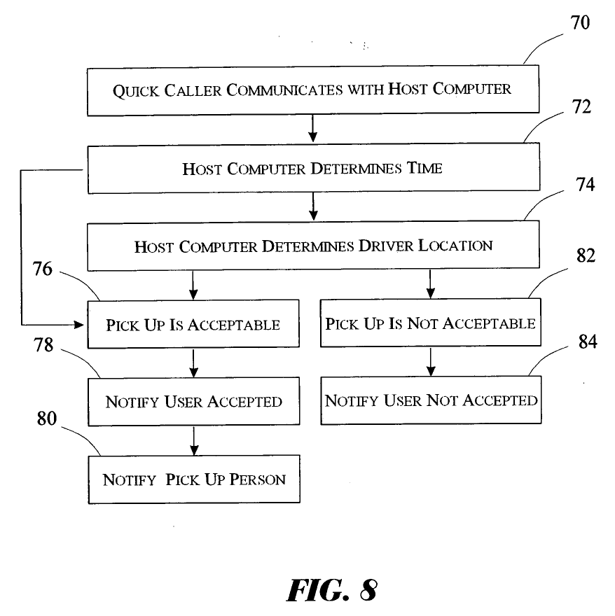

FIG. 8 is of a flow diagram describing a parcel pick up request process flow of a single switch remote access apparatus 200. In a first parcel pick up request step 70, the user would select the human interface input member 252 of the single switch remote access apparatus 200. In the preferred embodiment, the human interface input member 252 would be a popple switch located under a flexible label. A unique label can be designed for each customer. The single switch remote access apparatus 200 then communicates the request for pick up with the host computer 262. The host computer 262 can be a server connected to the internet. In a second parcel pick up request step 72, the host computer 262 would determine the time of day. If the time of day requesting the pick up is prior to a predetermined time (such as 4:00 PM daily), the host computer would jump to a fourth third parcel pick up request step 76 and automatically acknowledge the request for pick up and include the request in the route planning for the service person/driver. If the time of the request is equal to or after a predetermined time of day, the host computer 262 would continue to a third parcel pick up request step 74. In the third parcel pick up request step 74, the host computer 262 would determine the location of the driver. This can be accomplished in many ways. One such means would be a network of telemetry units installed within the service vehicle and interconnected with a Global Positioning System (GPS). A second means would be having the drivers transmit upon pick up at each customer location. The host computer 262 would track the location of each driver from the transmitted pick up points. The host computer 262 determines from the position of the driver, the time of day and the remaining required parcel pick ups, if the service person/driver has sufficient time to make the requested pick up. In the fourth parcel pick up request step 74, the host computer 262 determines that the pick up request has been accepted. In a fifth parcel pick up request step 78, the host computer 262 would acknowledge the request for pick up, sending a communication back to the single switch remote access apparatus 200. The single switch remote access apparatus 200 would communicate the acceptance of the request for pick up to the user via the human interface output member 268. In a sixth parcel pick up request step 82, the host computer 262 would notify the service person/driver that a parcel pick up is required at the requested location. The notification can be made via text messaging, route planner, cell phone, pager, radio, wireless host computer to vehicle computer means, and any other means of communicating to the driver. In the preferred embodiment, the host computer would provide a message to a display, the message indicating the next one, two or three pick up locations. The driver would acknowledge each pick up as it is completed and the host computer would transmit updates to the required parcel pick up locations. In an alternate fourth parcel pick up request step 82, the host computer 262 would determine that the request for pick up is not acceptable. In an alternate fifth parcel pick up request step 84, the host computer 262 would reject the request for pick up, sending a communication indicating the request for pick up is not acceptable back to the single switch remote access apparatus 200. The single switch remote access apparatus 200 would communicate that the request for pick up has not been accepted to the user via the human interface output member 268.

1. A single step notification apparatus, the apparatus comprising:
an electronic memory device,
a uProcessor,
at least one of a wired communications circuitry and a wireless communications circuitry,
a human interface input member,
a human interface output member, and
a software program, the software program comprising the steps:
1) recognizing a single change in the human interface input member,
2) communicating a preprogrammed information set to a preprogrammed external location,
3) receiving a response from the external location,
4) presenting the response from the external location by a change in the human interface output member.

2. The single step notification apparatus of claim 1, wherein the software program is preprogrammed to communicate with a parcel delivery company.

3. The single step notification apparatus of claim 1, wherein the at least one of a wired communications circuitry and a wireless communications circuitry is a wired communications circuitry, comprising the circuitry for at least one of Ethernet, modem, DSL, and cable modem.

4. The single step notification apparatus of claim 1, wherein the software program is preprogrammed to communicate with a parcel delivery company.

5. The single step notification apparatus of claim 1 wherein the human interface output member is at least one of an LED, a multicolored LED, a speaker, and an LCD.

6. The single step notification apparatus of claim 1 wherein the human interface output member indicates at least one of communicating in process, request accepted, and request not accepted.

7. A method of notifying a parcel delivery company that a pick up for a parcel is requested, the method comprising the steps:
a requester selects a single switch request input member,
a circuit recognizes a change in status of the input member,
a processing circuit identifies contact information for a remote location, wherein the remote location is located external to the requestor's facility and to where a request for pick up is to be communicated to,
the processing circuit identifies information respective to the location requesting a pick up, and
a communication circuit communicates between the processing circuit and the remote location.

8. The method of notifying a parcel delivery company that a pick up for a parcel is requested of claim 7, the method further comprising the steps:
the remote location determines a conclusion of the request for pick up,
the remote location communicates the conclusion of the request to the processing circuit,
the processing circuit conveys the conclusion of the request to the requestor by a human interface output member.

9. The method of notifying a parcel delivery company that a pick up for a parcel is requested of claim 8, the method further comprising the steps:
indicating a system status to the requester, wherein the human interface output member indicates when the system is communicating with the remote location.

10. The method of notifying a parcel delivery company that a pick up for a parcel is requested of claim 7, the method further comprising the steps:
programming the contact information for a remote location and the information respective to the location requesting a pick up into the system.

11. An parcel drop box and integrated pick up request notification apparatus, the apparatus comprising:
a parcel drop box,
a transmitter,
a power supply,
a sensor which monitors when a sensor is deposited within the parcel drop box, and
at least one of a circuit and software which causes the transmitter to transmit a message requesting a pick up of a parcel.

12. The parcel drop box and integrated pick up request notification apparatus of claim 11, the apparatus further comprising:
at least one of a software and a circuit which turns the transmitter on when the a message is to be transmitted.

13. The parcel drop box and integrated pick up request notification apparatus of claim 11, the apparatus further comprising:
an apparatus which applies a charge to the power supply.

14. The parcel drop box and integrated pick up request notification apparatus of claim 13, wherein the apparatus which applies a charge to the power supply is at least one of a solar panel and a power source which applies power to the batteries upon a motion applied to a component of the parcel drop box.

15. The parcel drop box and integrated pick up request notification apparatus of claim 11, the apparatus further comprising a receiver and at least one of software and circuitry which repeats the transmission of the message requesting a pick up of a parcel until an acknowledgement of the transmitted message is received.

16. The parcel drop box and integrated pick up request notification apparatus of claim 11, the apparatus further at least one of software and circuitry which is activated at a desired timeframe, determines if a parcel has been deposited within the parcel drop box, and transmits a message indicating if a pick up is required.

17. The parcel drop box and integrated pick up request notification apparatus of claim 16, the apparatus further comprising a receiver and at least one of software and circuitry which repeats the transmission of the message indicating if a pick up is required until an acknowledgement of the transmitted message is received.

18. The parcel drop box and integrated pick up request notification apparatus of claim 11, the apparatus further comprising a host computer, wherein the host computer receives the transmitted message.

19. The parcel drop box and integrated pick up request notification apparatus of claim 18, wherein the host computer at least one of directly and indirectly notifies a service person to pick up a parcel at the parcel drop box that transmitted the message.

20. The parcel drop box and integrated pick up request notification apparatus of claim 11, the apparatus further comprising:
an access door where the user would deposit a parcel, and
at least one of a software and a circuit which turns the sensor which monitors when a sensor is deposited within the parcel drop box on when the access door is opened.
